(19) United States
(12) Patent Application Publication
(10) Pub. No.: US 2011/0271844 A1
(43) Pub. Date: Nov. 10, 2011

(54) CAPSULE FOR PREPARING A BEVERAGE, AND DEVICE

(76) Inventors: Alain Mariller, Le Mont-Pelerin (CH); Jean-Paul Gaillard, Cully (CH); Sylvain Goy, Montcherand (CH)

(21) Appl. No.: 13/143,143

(22) PCT Filed: Dec. 7, 2009
(86) PCT No.: PCT/IB2009/055549

§ 371 Date: Jul. 28, 2011

(30) Foreign Application Priority Data
Jan. 2, 2009 (IB) PCT/IB2009/050002

(51) Int. Cl. B65D 85/804; A47J 31/36

(52) U.S. Cl. 99/295; 426/77

(57) ABSTRACT

The invention relates to a capsule for preparing a beverage, for example coffee, including a hollow element (1) for containing a metered amount of ground coffee, for example, said hollow element (1) including a side wall (2), an injection surface (3) and an extraction wall (4) for extracting a mixture of water and coffee; said capsule including at least one self-piercing raised pattern (5) arranged on said extraction wall (4). The invention also relates to a device for using said capsule.

### FIELD OF THE INVENTION

The present invention lies in the field of the preparation of beverages, for example based on coffee, by extracting a concentrated serving, for example of ground coffee, contained in a capsule. It relates more particularly to servings used for this purpose and to devices using such servings.

### PRIOR ART

Capsules and machines that operate according to the abovementioned principle have existed for many decades.

U.S. Pat. Nos. 2,899,886, 2,968,560, 3,403,617 and 3,607,297 describe devices in which the capsule is first of all perforated at a number of locations and then is passed through by pressurized water.

The capsule described in patent CH 605 293 or in patent EP 0 242 556 B1 has a membrane in its lower part. Pressurized water is first of all introduced into the upper part of the capsule, after said capsule has been pierced by means of a sharp element (for example a blade), causing the capsule to swell, mainly at the membrane. Beyond a certain pressure, the membrane tears, thereby allowing a water-coffee mixture to flow.

Further capsules provided with a membrane are described in the following patents: EP 0 468 079 A, EP 0 806 373 A, EP 0 554 469 A.

### SUMMARY OF THE INVENTION

One of the objectives of the present invention is to improve the water-coffee mixture which is produced inside the capsule.

Another objective is to improve the piercing of the capsule at its extraction face.

Another objective consists in simplifying the maintenance of devices for capsules.

These objectives are achieved by providing the extraction wall of the capsule with one or more self-piercing reliefs.

The reliefs are located and designed in such a way as to perforate while they are being deformed, preferably simultaneously, by a deforming element, for example the base of the capsule holder, on which the capsule is supported.

In the present invention, the reliefs can be formed by embossing, stamping, thermoforming or any other method suitable for the aim which is sought.

The reliefs are characterized in that they take up a relatively small area, in any case much smaller than the total surface area of the extraction wall of the capsule. Thus, when a solid element, such as the base of the capsule holder, exerts a pressure on the extraction wall, it is at the reliefs that the capsule is pierced in that said reliefs deform, resulting in self-perforation.

### DETAILED DESCRIPTION OF THE INVENTION

The invention is described in more detail hereinbelow by means of nonlimiting examples illustrated in the following figures, in which:

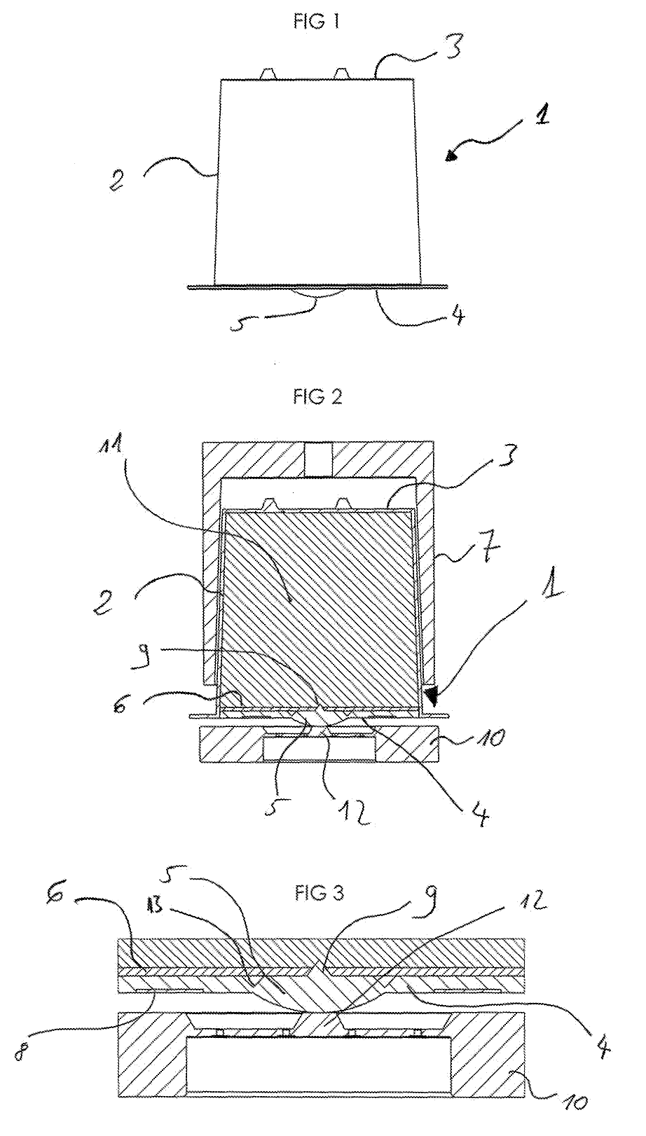

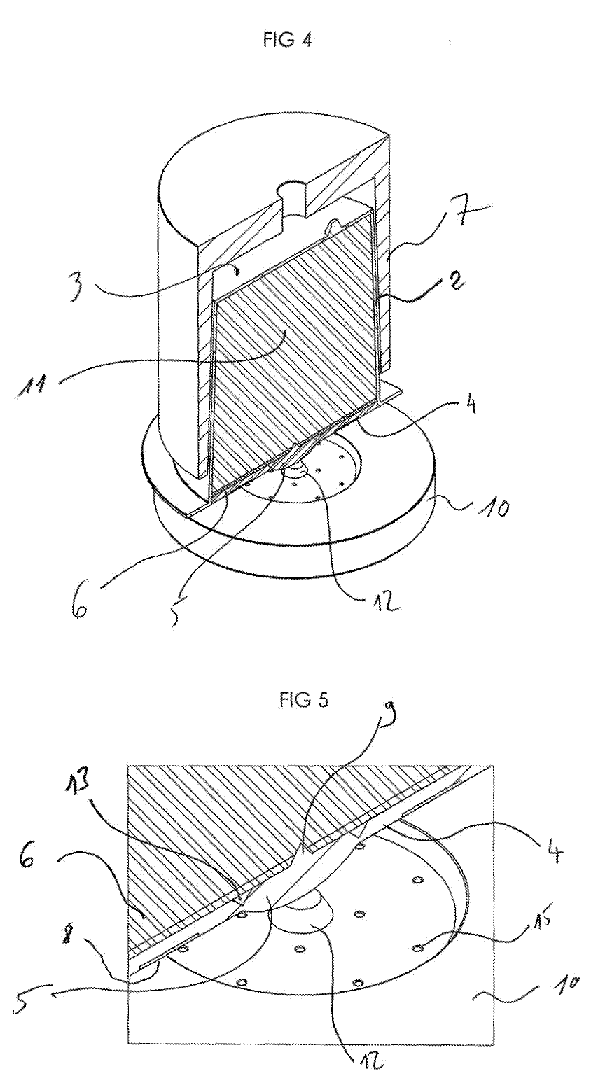

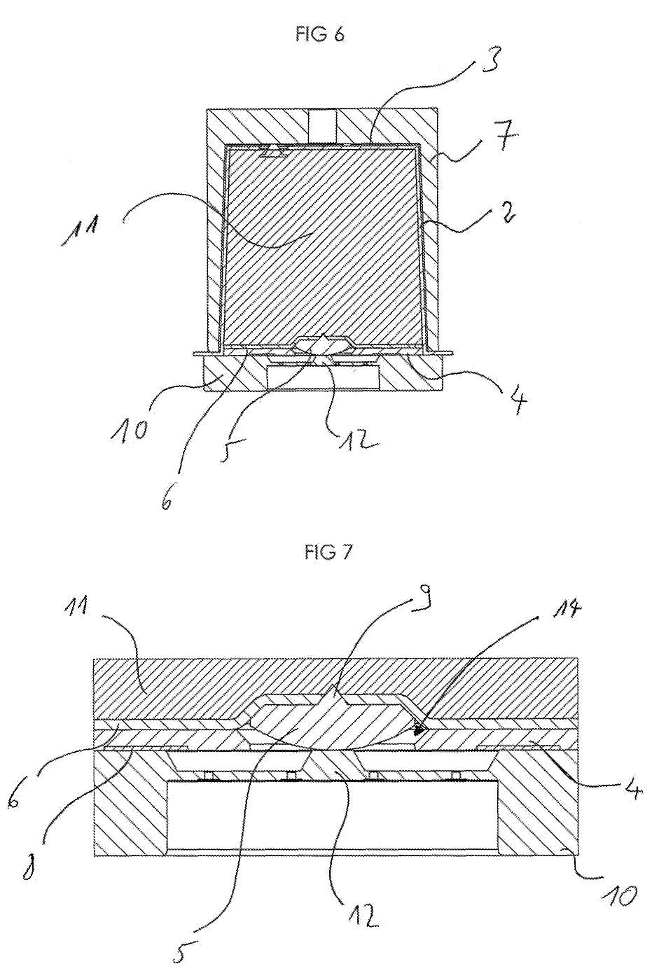

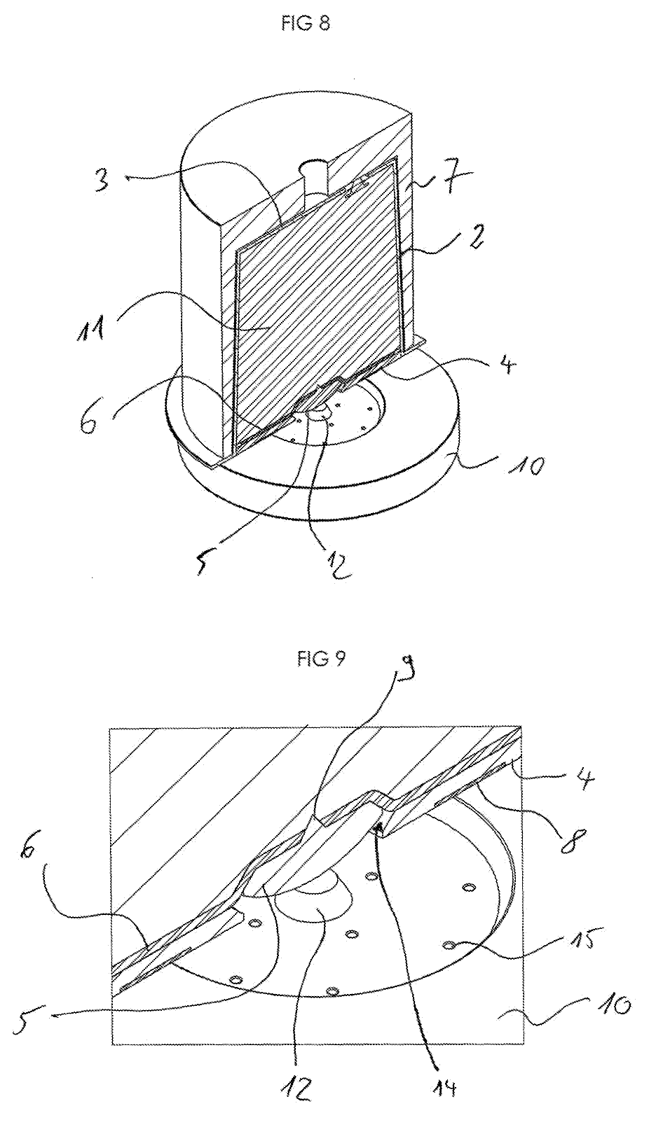

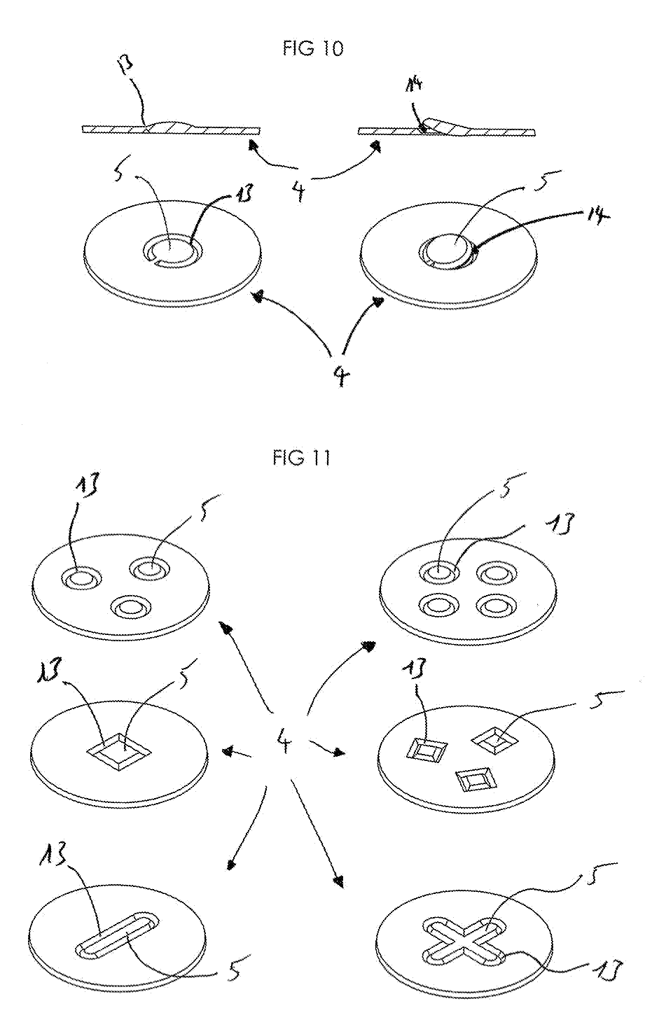

FIG. 1 illustrates a simplified view of a first example of a capsule according to the invention,

FIG. 2 illustrates the capsule from FIG. 1 inside an extraction device in the rest mode,

FIG. 3 shows an enlarged view of the lower part of the capsule from FIG. 2,

FIGS. 4 and 5 show perspective views of the capsule from FIGS. 2 and 3,

FIG. 6 illustrates the capsule from FIG. 1 inside an extraction device in the extraction mode,

FIG. 7 shows an enlarged view of the lower part of the capsule from FIG. 6,

FIGS. 8 and 9 show perspective views of the capsule from FIGS. 6 and 7,

FIG. 10 shows an embodiment of a relief having an attachment point, and

FIG. 11 shows different shapes of reliefs that can be used in the scope of the present invention.

List of reference numerals used in the figures:
1. Hollow body
2. Side wall
3. Injection face
4. Extraction wall
5. Self-piercing relief
6. Semipermeable element
7. Capsule housing
8. Annular element
9. Spike
10. Capsule holder
11. Serving, for example of coffee
12. Protuberance
13. Weakening zone
14. Extraction zone
15. Orifice

FIGS. 1 to 5 illustrate one variant among others of a capsule according to the invention in the rest position.

The capsule is composed of a hollow element 1 formed by a side wall 2, an upper wall 3 and a lower wall 4.

The lower wall 4 is relatively rigid. It consists preferably of a biodegradable material. Any form of material suitable for the envisioned, use can be used. If it is a biodegradable material, use can be made, for example, of a mixture comprising starch (>70%), fibers, proteins, lipids and at least one biodegradable resin.

Of course, the upper wall 3 and/or the side wall 2 can likewise be made of a biodegradable material.

The outer face of the lower wall 4 has a self-piercing relief 5 in the form of a boss (portion of a sphere) in the example illustrated. This boss is in fact an overthickness of the lower wall 4. Around the boss there is disposed a peripheral zone, called weakening zone 13, having a thickness less than the thickness of the rest of the lower wall 4.

Inside the capsule, on the lower wall 4, there is disposed an optional, for example knitted, semipermeable element 6 which allows liquid to pass through but holds back solid substances such as coffee grounds.

Still inside the capsule, the relief 5 is extended in the form of a spike 9. The presence of the latter is optional. Specifically, it makes it possible to keep the relief 5 centered when the latter moves toward the inside of the capsule.

The optional annular element 8 is preferably formed from a material, for example paper, that makes it easier to remove the capsule once it has been used. Its presence can prove useful if the, for example biodegradable, material which forms the capsule tends to adhere to the capsule holder when it is heated.

FIGS. 6 to 9 illustrate the same capsule as the one shown in FIGS. 1 to 5 but in the extracting position, i.e. after the device around the capsule has been closed. In this configuration, the relief 5 has butted against a protuberance 12 located on the capsule holder 10, the effect of this being to drive the relief 5 into the capsule, in this way breaking the weakening zone 13. At this point, a passage for the liquid is formed, this passage being called the extraction zone 14 and having an annular form in the present case.

It will be noted that the presence of the semipermeable element 6 keeps the solid material (grounds) inside the capsule.

The liquid passing through the extraction zone passes through the capsule holder 10 through orifices 15 provided to this end. The liquid (water-coffee mixture) is finally collected in a cup (not illustrated) located under the capsule holder 10.

The invention is not limited to the example illustrated in FIGS. 1 to 9.

Any form of relief can be envisioned. The same applies to the distribution and number of reliefs. FIGS. 10 and 11 show a number of variants among others.

Similarly, the base of the capsule holder 10 does not necessarily have a protuberance 12. It is possible for it not to contain one, or conversely it can contain a plurality thereof, for example a number equal to the number of reliefs located on the extraction wall.

Advantageously, the weakening zone can be rendered asymmetrical with respect to the center of the relief, thereby minimizing the risk of the relief accidentally clogging the extraction zone.

The extraction face 4 is advantageously coincident with the lower wall of the capsule. According to another variant of the invention (not illustrated), the extraction face is coincident with the upper wall of the capsule.

Similarly, see in particular FIG. 1, self-piercing reliefs can be located on that wall of the capsule which is opposite the extraction wall. In this case, the self-piercing reliefs ensure that water enters/is injected into the capsule.

It should be noted, finally, that, the invention is not limited to a specific form of capsule. Any form suitable for use (for example conical, cylindrical or cubic) can be used.

1. A capsule for preparing a beverage, for example coffee, comprising a hollow element (1) intended to contain a serving, for example of ground coffee, said hollow element (1) comprising a side wall (2), an injection face (3) and an extraction wall (4) suitable for the extraction of a water-coffee mixture; said capsule comprising at least one self-piercing relief (5) located on said extraction wall (4).

2. The capsule as claimed in claim 1, comprising a plurality of self-piercing reliefs (5).

3. The capsule as claimed in claim 1, in which the relief or reliefs is/are formed by embossing, stamping, thermoforming or any other similar process.

4. The capsule as claimed in claim 1, in which the self-piercing relief or reliefs (5) comprise(s) a peripheral weakening zone which has a thickness less than the thickness of the rest of the extraction wall (4).

5. The capsule as claimed in claim 4, in which said weakening zone is symmetrical about its relief (5) with which it is combined.

6. The capsule as claimed in claim 4, in which said weakening zone is asymmetrical about its relief (5) with which it is combined.

7. The capsule as claimed in claim 6, in which said weakening zone has a point of attachment having a thickness at least the same as that of the rest of the extraction wall (4).

8. The capsule as claimed in claim 1, in which each relief (5) has a circular base.

9. The capsule as claimed in claim 1, in which each relief (5) has a polygonal base.

10. The capsule as claimed in claim 9, in which each relief (5) has a cross-shaped base.

11. The capsule as claimed in claim 1, comprising reliefs (5) on its injection face (3).

12. The capsule as claimed in claim 1, comprising reliefs (5) on its side wall (2).

13. The capsule as claimed in claim 1, comprising a semipermeable element (8) located on the inner face of the extraction wall (4).

14. The capsule as claimed in claim 13, in which each relief (5) has a spike (9) located inside the capsule.

15. The capsule as claimed in claim 1, in which said extraction wall is made of a biodegradable material, for example comprising the following elements: starch (>70%), fibers, proteins, lipids and at least one biodegradable resin.

16. A device for using a capsule as defined in claim 1, comprising a capsule holder (10), a capsule housing (7), a water inlet and a perforating element, said capsule holder being designed to deform the relief or reliefs (5) of the capsule (1) in order to produce their self-perforation.

17. The device as claimed in claim 16, in which said capsule holder (10) has at least one protuberance (12) intended to come into contact with said relief (5).
